(19) United States
(12) Patent Application Publication
(10) Pub. No.: US 2005/0228877 A1
(43) Pub. Date: Oct. 13, 2005

(54) System for managing a device

(76) Inventors: Arnold Monitzer, Pullach im Isartal (DE); Frank Heer, Munchen (DE); Vamsi Chemitiganti, Coatesville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/076,749

(22) Filed: Mar. 10, 2005

Related U.S. Application Data
(60) Provisional application No. 60/560,334, filed on Apr. 7, 2004.

(51) Int. Cl. G06F 15/173

(52) U.S. Cl. 709/223

(57) ABSTRACT

A system for managing a device at a location of an associated entity includes a repository of device information identifying (a) the entity associated with the device, (b) the device, and (c) a characteristic indicating terms governing usage of the device by the entity. A communication processor communicates a message to the entity location identifying the device and updating the terms governing usage of the device.

### CROSS REFERENCE TO RELATED APPLICATIONS

This is a non-provisional application of provisional application Ser. No. 60/560,334, by Arnold Monitzer, filed Apr. 7, 2004.

### FIELD OF THE INVENTION

The present application relates to a system for managing a device, and more particularly, a system for managing the usage of such a device.

### BACKGROUND OF THE INVENTION

Computer systems typically include a central processing unit (CPU), a memory, and a set of hardware devices which are interconnected to form a computer system; and software which executes on the processor and interacts with the hardware devices to provide functions desired by the user. Some hardware is built into the computer system, and some hardware may be attached to and detached from the computer system via various physical connections, such as cables or edge connectors, and electrical signal communications arrangements, such as serial or parallel digital buses, analog signal wires, wireless radio links, and so forth. Some such computer systems are generalized, multi-purpose computer systems which may be adapted to many uses. Other such computer systems are specific, single, or limited, purpose computer systems. In either case, there is often a desire to expand the computer system in terms of the hardware, software or both.

Expanding the computer system software has raised many problems. Some of these problems relate to the developer of the software being paid for the software. Illegal copies of software may be easily made and distributed because the media on which software is transmitted may be easily copied. License fees are not paid to the manufacturer for such illegal copies. One attempt to solve this problem is to require that a software user contact the software developer to request an installation of the software on a computer system. The software developer may then verify that the license fee was paid for this copy, and mark this copy of the software as in use on a particular computer system. Only then will the software install and operate on that computer system. Any attempt to install the software on a different computer system will fail.

Expanding the computer system hardware has been less problematic because it is much more difficult to make an illegal copy of hardware. However, in some cases vendor control of hardware expandability is desirable. For example, in server computer systems, which provide services over a network, e.g. the internet, a user may determine the average load on the servers and purchase computer systems with the capacity to provide services at that average load. However, there will be periods when the load may peak at a level beyond the capacity of the server computer system. Purchasing a server computer system which has the capability to provide services at the peak load level may be too expensive and inefficient, because most of the time, the load will be below the peak level.

One solution to the problem has been to provide a computer system with multiple processors, and/or memory devices. A subset of these processors and/or memory devices may be purchased and initially activated. In the example above, these processors and/or memory devices are sufficient to deal with the average load. When load increases, further processors and/or memory devices may be activated to handle the increased load. The devices may be activated by contacting the manufacturer of the computer system, such as by telephone, mail or e-mail. The manufacturer then sends instructions on how to activate the desired processors and/or memory devices and sends a bill to the customer.

This process takes time for communications between the customer and the manufacturer. In addition, manual intervention by an information technology person is required to activate the desired processors. It is desired to provide a method of activating additional hardware devices automatically by a user of such devices.

### BRIEF SUMMARY OF THE INVENTION

In accordance with principles of the present invention, a system for managing a device at a location of an associated entity includes a repository of device information identifying (a) the entity associated with the device, (b) the device, and (c) a characteristic indicating terms governing usage of the device by the entity. A communication processor communicates a message to the entity location identifying the device and updating the terms governing usage of the device.

### BRIEF DESCRIPTION OF THE DRAWING

In the drawing:

FIG. 1 is a block diagram of a system for controlling a device;

FIG. 2 is a diagram illustrating data stored in the license key storage device illustrated in FIG. 1;

FIG. 3 is a diagram illustrating data stored in the persistent key storage device illustrated in FIG. 1;

FIG. 4 is a flow diagram illustrating the method of controlling a device during power-on of equipment containing the device;

FIG. 5 is a flow diagram illustrating the method of controlling a device after power-on of equipment containing the device;

FIG. 6 is a more detailed block diagram of the license server as illustrated in FIG. 1;

FIG. 7 is an illustration of a graphical user interface display image showing the usage of the devices controlled; and

FIG. 8 is an illustration of a graphical user interface display image for soliciting further information necessary for changing the usage status of a device.

### DETAILED DESCRIPTION OF THE INVENTION

As used herein, a processor operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application as used herein comprises code or machine readable instructions for conditioning the processor to implement predetermined functions, such as those of an operating system, healthcare information system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface comprises one or more display images, generated by the display processor under the control of the processor, enabling user interaction with a processor or other device.

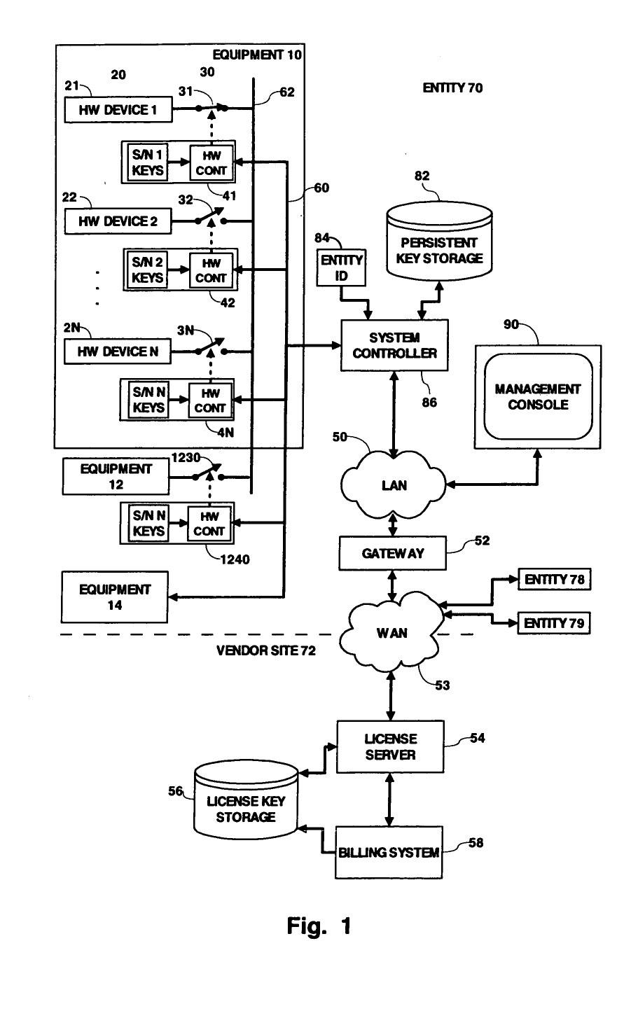

FIG. 1 is a block diagram of a system for managing a device. In FIG. 1, an entity 70 is connected to a vendor site 72 via a wide area network (WAN) 53. The WAN 53 may be any form of wide area network, such as the internet, a private interconnection network between the entity 70 and the vendor site 72, or any other such data communications network. The WAN 53 may also be connected to other such entities, such as entity 78 and entity 79. Although three such entities are illustrated in FIG. 1, any number of entities may be interconnected with the vendor site 72 in this manner. Further, the entities 70, 78, 79 may be collocated with each other, with the vendor site 72 or may be located remotely from the vendor site 72 and each other. The entity may be at least one of (a) an organization, (b) a subunit within an organization, and (c) an organization subunit associated with a particular location. At the vendor site 72, a license server 54 is coupled to the WAN 53. The license server 54 is coupled to a billing system 58. A license key storage device 56 is coupled to the license server 54 and the billing system 58.

The entity 70 includes a local area network (LAN) 50 which is connected to the WAN 53 through a gateway 52. The gateway 52 operates in a known manner to interconnect the LAN 50 to the WAN 53. The entity 70 further includes electronic equipment 10, 12, and 14. The electronic equipment 10, 12, 14 operates to perform functions. For example, in a healthcare entity 70, the electronic equipment 10, 12, 14 may be patient monitoring and/or treatment equipment, such as patient monitors, fluid management devices, ventilators, and so forth. The electronic equipment 10 includes a plurality of N independently controllable hardware devices 21, 22, . . . 2N. The other electronic equipment 12, 14 may include one or more controllable hardware devices as well.

Referring now to the electronic equipment 10, hardware devices 21, 22, 2N may be controllably enabled and disabled, illustrated schematically by respective switches 31, 32, 3N coupled between the hardware devices 21, 22, 2N and a data bus 62. The state of the switch 31 is closed, indicating that the hardware device 21 is enabled and may be used; the states of the switches 32 and 3N are open, indicating that the hardware devices 22 and 2N are disabled and may not be used. This is a schematic indication only, and one skilled in the art understands that any of a number of known methods may be used to enable or disable devices. For example, a hardware reset line may be held in a known reset state to disable a device and allowed to leave the reset state to enable a device. As another example, power may be switched on and applied to a device to enable it, and switched off to disable it. One skilled in the art understands: (a) that these or any other appropriate techniques may be used to enable and disable hardware devices; (b) how to design and implement a desired technique; and (c) the tradeoffs involved in selecting one of the known techniques.

The switches 31, 32, and 3N are controlled by respective controllers 41, 42 and 4N. The controllers 41, 42 and 4N include a hardware control device and a memory device storing a serial number of the associated hardware device 21, 22, 2N and one or more usage keys also associated with the hardware device 21, 22, 2N. When the equipment 10 is fabricated, data representing the serial number of the hardware device and the usage keys is permanently stored in the memory device. The controllers 41, 42, 4N are designed so that the serial number of the hardware device 21, 22, 2N may be retrieved from the memory device and made available to outside circuitry. The usage keys, however, are accessible only to the hardware control device; i.e. they are unavailable to circuitry outside the controller 41, 42, 4N. The hardware control device is illustrated schematically as controlling the state of the associated switch 31, 32 and 3N. That is, in the manner described above, the hardware control device conditions the hardware device 21, 22 and 2N to be enabled or disabled. In the embodiment illustrated in FIG. 1, the hardware control device in the controller 41 has enabled the associated hardware device 21, while the respective hardware control devices in controllers 42 and 4N have disabled the associated hardware devices 22 and 2N.

In a similar manner, electronic equipment 12 is coupled to the data bus 62 through a switch 1230. The switch 1230 is controller by a controller 1240. The controller 1230 is similar to the controllers 41, 42, 4N described above. The controller 1240 operates in the same manner as the controllers 41, 42, 4N to enable or disable the equipment 12. One skilled in the art, therefore, understands that devices, such as electronic equipment 12 or hardware devices 21, 22, 2N implementing individual functions within a piece of electronic equipment may be enabled or disabled in this manner. The remainder of the written description will focus on the electronic equipment 10 and the devices 21, 22, 2N in it.

A system controller 86 is coupled to the controllers 41, 42 and 4N in the equipment 10, 12, 14 via a control bus 60. The controllers 41, 42 and 4N interact with the system controller 86, in a manner to be described below, to control the usage of hardware devices 21, 22 and 2N. The system controller 86 is also coupled to a persistent key storage device 82 and a storage device 84 containing data representing the identification of the entity 70. The system controller 86 is also coupled to the LAN 50. A management console 90 is also coupled to the LAN 50. In the illustrated embodiment, the management console 90 may be a terminal having a display device, such as a CRT or LCD screen, for displaying images; and input devices, such a keyboard and/or mouse, for receiving input data from a user. One skilled in the art understands that more than one management console 90 may be coupled to the LAN 50.

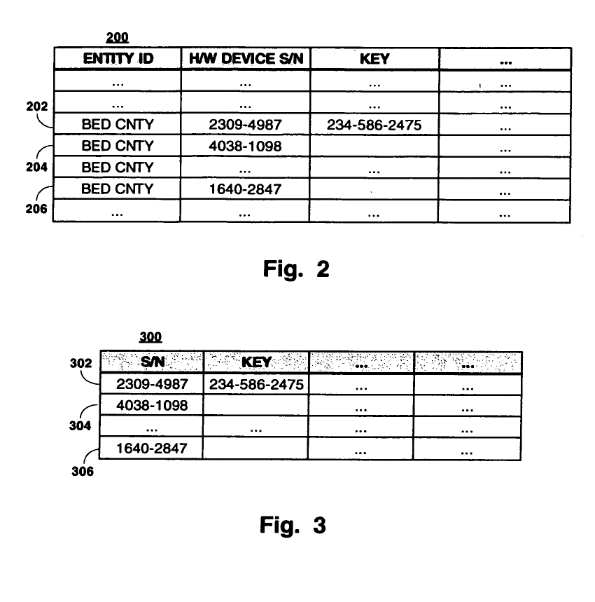

In operation, the license key storage device 56 at the vendor site 72 is a repository of device information for hardware devices 21, 22, 2N at the entity locations 70, 78, 79. FIG. 2 illustrates a table 200 containing a pertinent portion of the data stored in the license key storage device 56. When the vendor places a piece of electronic equipment 10 at the entity 70, records containing data related to the devices 21, 22, 2N that are in that equipment 10 are stored in the license key storage device 56 at the vendor location 72.

The first column of those rows contains the entity ID of the entity 70 (FIG. 1) which received the equipment 10, and the second column contains the serial numbers of the respective devices 21, 22, 2N in that equipment 10. The third column contains a KEY having a value which may be used to identify terms governing use of the related device 21, 22, 2N. For example, a first key value may indicate that the associated device 21, 22, 2N is owned by the entity, and thus may be used at any time. A second key value may indicate that the associated device 21,22,2N is rented for a period of time, and may not be used after the period of time expires. A third key value may indicate that the associated device 21, 22, 2N is under a long term lease, and may be used until the lease is terminated. A fourth key value, represented as a blank or null in table 200 (FIG. 2), may indicate that the associated device is available for purchase, rental or lease. These key values may be calculated in such a manner that they include respective components representing: (a) the value of the entity ID, (2) the hardware serial number; (3) the usage (purchase, rental, lease) which has been paid for by the entity; and/or (4) any other data deemed important to governing usage of the device. More specifically, in the illustrated embodiment, for devices which have been rented or leased, as described above, the key value may also include a component representing either the length or the ending date of the rental or lease period. The use of these key values will be described in more detail below.

Other columns in table 200 may include other information about the associated devices. These other columns may contain data representing e.g. a device ID, a device type, the operational status of the individual device, the availability of the individual device for usage by the entity, the status of a request for the usage terms of an individual device, the name and address of the entity, the physical location of the associated device within the entity location, a picture of the device, the name and manufacturer of the device and/or electronic equipment, the patient name, doctor name, patient monitoring and/or treatment parameters, and so forth.

In FIG. 2, the rows 202, 204 and 206 are respectively associated with devices 21, 22, and 2N (FIG. 1) at entity location 70. The first column of rows 202, 204 and 206 identify the related devices 21, 22, 2N as being located at an entity identified by the entity ID “BED CNTY”. The second column of row 202 contains data which identifies device 21 by its serial number “2309-4987”; the second column of row 204 contains data which identifies device 22 by its serial number “4038-1098”′; and the second column of row 206 contains data which identifies device 2N by its serial number “1640-2847”. The third column of row 202 includes a key “234-586-2475”, while the third column of rows 204 and 206 are blank.

In FIG. 2, the device 21, represented by row 202, is owned by the associated entity 70. The key value “234-586-2475” has been calculated to include a component identifying the entity which purchased the device, i.e. “BED CNTY”; a component identifying the device 21, i.e. the serial number “2309-4987”; and a component identifying that the entity 70 has purchased this device 21. The devices 22 and 2N, represented by rows 204 and 206 respectively, have not been acquired in any form and may not be used by the entity 70. Instead, they are available to be purchased, rented or leased by the entity 70, as indicated by the blank or null values stored in the third KEY column.

At the entity location 70 (FIG. 1), the persistent key storage device 82 also stores data related to the hardware devices at the entity location 70, as illustrated in table 300 in FIG. 3. The structure of the data in table 300 in the persistent key storage device 82 is similar to that of the data in table 200 in FIG. 2. In FIG. 3, the rows of table 300 contain data related to respective corresponding hardware devices. In table 300, row 302 contains data related to hardware device 21, row 304 contains data related to hardware device 22, and row 306 contains data related to hardware device 2N. The columns contain respective data items related to the corresponding hardware device. The first column contains data which represents the respective serial numbers, 2309-4987, 4038-1098, 1640-2847, of the corresponding hardware devices 21, 22, 2N. The second column represents a key for the corresponding hardware devices: 234-586-2475 for device 21, blank for devices 22 and 2N. Further columns contain further data related to the corresponding hardware devices 21, 22, 2N.

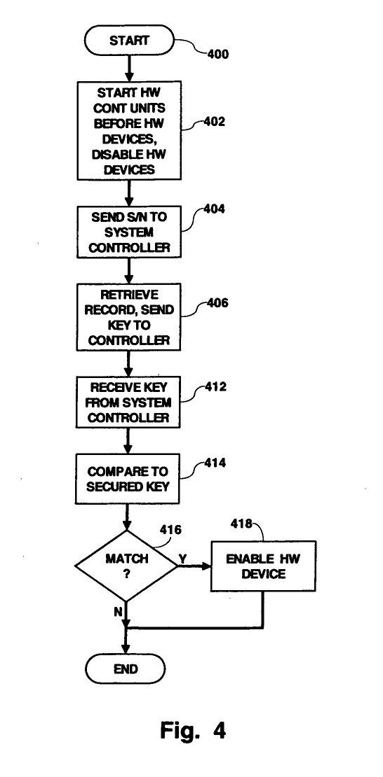

FIG. 4 is a flow diagram illustrating the method of controlling a device 21, 22, 2N (FIG. 1) during power-on of the electronic equipment 10, 12, 14 containing it. At the entity location 70, the controllers 41, 42, 4N enable or disable the associated hardware device 21, 22, 2N, in the manner described above. When the electronic equipment 10, 12, 14 is powered-on, the controllers 41, 42, 4N determine whether the associated device may be enabled and used. In step 402, the controllers 41, 42 and 4N are powered on before the hardware devices 21, 22, 2N and initially condition the associated hardware devices 21, 22, 2N to be disabled. In step 404, the controllers 41, 42, 4N retrieve the serial number of the associated device 21, 22, 2N from the memory device and send it to the system controller 86.

In step 406, in response to the receipt of the serial number identifying a hardware device 21, 22, 2N, the system controller 86 retrieves information from the persistent key storage device 82 related to the identified hardware device 21, 22, 2N. More specifically, in the illustrated embodiment the row of table 300 (FIG. 3) containing the serial number received from the controller 41, 42, 4N is retrieved and the usage key value from that row is sent back to the controller 41, 42, 4N. In step 412, the hardware controller 41, 42, 4N receives the usage key value from the system controller 86 and in step 414, compares the received usage key value to the value of the usage key or keys securely stored in the storage device in the controller 41, 42, 4N. In step 416, if the usage key received from the system controller 86 matches a key in the storage device in the controller 41, 42, 4N, then in step 418 the hardware control device in the controller 41, 42, 4N enables the associated hardware device 21, 22, 2N, allowing it to start operation. If the usage key received from the system controller 86 does not match a key in the storage device in the controller 41, 42, 4N, then the controller 41, 42, 4N does not enable the associated hardware device 21, 22, 2N, and it remains disabled.

As described above, while the serial number of the hardware device 21, 22, 2N, stored in the storage device in the controller 41, 42, 4N, is available to devices outside the controller 41, 42, 4N, the usage keys are not. Thus, the device 21, 22, 2N is enabled if the usage key in the persistent key storage device 82 matches the key previously stored by the vendor in the storage device in the controller 41, 42, 4N, and disabled otherwise. Further, as described above, the usage key may include components representing the entity, the device and the permitted usage. This provides security that devices may be used only with permission of the vendor 72.

Under normal conditions, the persistent key storage 82 (FIG. 1) maintains the data illustrated in FIG. 3. However, there may be situations where there is no data in the persistent key storage device 82 representing one or more of the hardware devices 21, 22, 2N. For example, no data will be present in the persistent key storage device 82 at the first power-on of newly installed electronic equipment 10 or if a malfunction occurs in the persistent key storage device 82 requiring its replacement. Similarly, the persistent key storage device 82 may contain data representing a hardware device 21, 22, 2N, but no valid usage key. For example, the devices 22 and 2N have been installed but have not been authorized for use by the vendor 72.

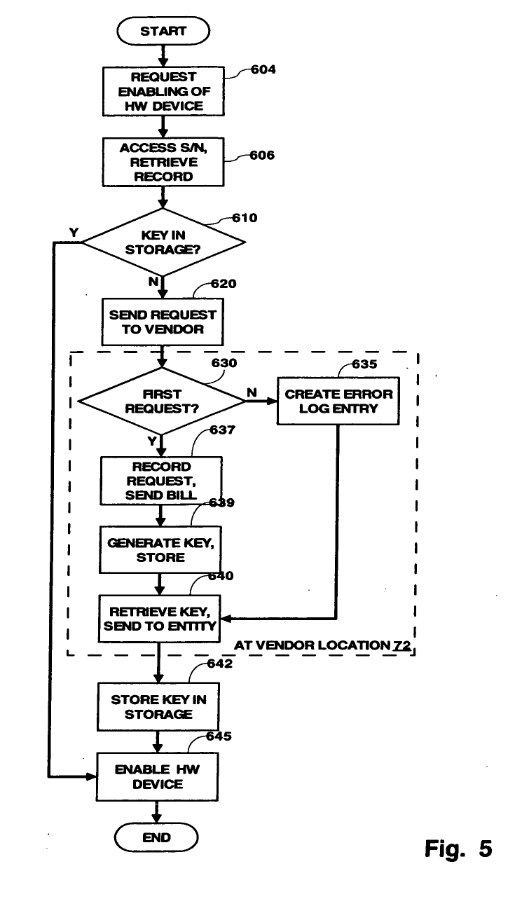

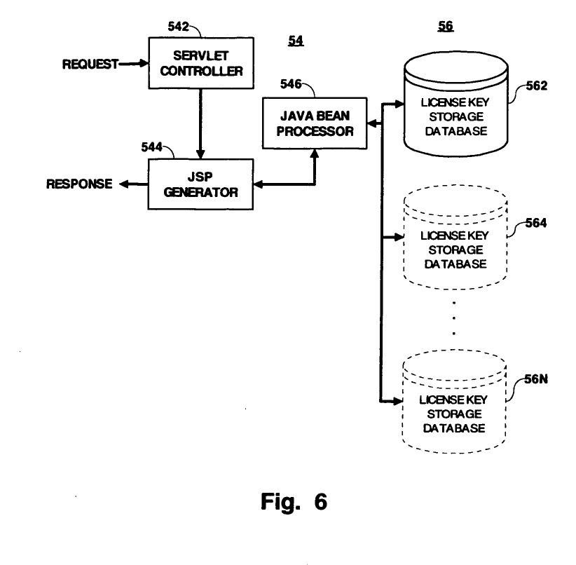

FIG. 5 is a flow diagram illustrating the method of activating a device 21, 22, 2N (FIG. 1) in a piece of electronic equipment 10, 12, 14. In the following description, it is assumed that a user at the entity location 70 desires to enable a currently disabled hardware device 21, 22, 2N. In step 604, the user may use the management console 90 to request enabling of the desired hardware device 21, 22, 2N. More specifically, in the illustrated embodiment the user conditions the management console 90 to send a message via the LAN 50 to the system controller 86 to request enabling of a desired device 21, 22, 2N. In step 606, the system controller 86 sends a request to the controller 41, 42, 4N associated with the desired device 21, 22, 2N to return its serial number. In response to the receipt of the serial number from the controller 41, 42, 4N, the system controller 86 retrieves the record containing that serial number from table 300 (FIG. 3) in the persistent key storage device 82, as described above. In step 610 it is determined if such a record exists and if a usage key exists in the retrieved record. If so, the usage key is sent to the controller 41, 42, 4N associated with the desired device 21, 22, 2N. In step 645, in response to the receipt of the usage key, the controller 41, 42, 4N enables the desired device 21, 22, 2N as described above.

If, however, the system controller 86 (FIG. 1), does not find a key in table 300 (FIG. 3) in the persistent key storage device 82, then in step 620 a request is sent to the vendor 72 for a usage key. More specifically, in the illustrated embodiment the system controller 86 sends a message to the license server 54 at the vendor location 72 via the LAN 50, the gateway 52, and the WAN 53 requesting a usage key. The message includes data representing the serial number of the device 21, 22, 2N and data representing the entity ID, stored in the entity ID storage device 84. Other data may also be included in the message sent to the license server 54 from the entity location 70: for example, data representing the desired usage type, i.e. purchase, rental or long term lease; the desired term for rental or long term lease; and/or data identifying (i.e. user name), and verifying the authorization of (i.e. password), the user making the request.

The license server 54 (FIG. 1) at the vendor location 72 includes a communications processor which operates to receive requests from entity locations 70, 78, 79 to enable a device 21, 22, 2N, identified, for example, by the entity ID and the device serial number, and to communicate a message to the requesting entity location 70, 78, 79 identifying the device 21, 22, 2N and updating the terms governing usage of that device 21, 22, 2N. More specifically, in the illustrated embodiment, in response to the receipt of a request for a usage key for a desired device 21, 22, 2N, the license server 54 determines in step 630 (FIG. 5) if this is the first request to activate the desired device 21, 22, 2N. In the illustrated embodiment, this may be done by accessing the license key data table 200 (FIG. 2) in the license key storage device 56 to determine if there is a record corresponding to the hardware device 21, 22, 2N, as identified by the serial number and entity ID. If a corresponding record exists, then the value of the KEY column is checked to determine if a usage key has already been assigned.

If a usage key has not already been assigned, this indicates that this is the first request to activate the desired device 21, 22, 2N (FIG. 1). In this case, in step 637, the request is recorded in a log, and a message sent to the billing system 58. The billing system 58 operates to send a bill to the requesting entity for activating the desired device 21, 22, 2N. The operation of the billing system 58 is not germane to the illustrated embodiment and is not described in detail. However, in general, the license server 54 sends a message to the billing system 58 indicating that a selected hardware device 21, 22, 2N has been enabled. This message may include other information, such as the identity of the user which requested enabling the device 21, 22, 2N. In step 639 a usage key is generated containing components based on the entity ID, the device 21, 22, 2N serial number, the type of usage desired, i.e. purchase, rental or lease, and any other information deemed important, as described above. This usage key is then stored in the KEY column of the corresponding row of the license key data table 200 (FIG. 2) in the license key storage device 56.

Referring again to step 630, if a usage key is previously assigned, this indicates that this is not the first request to enable this device. Because a request is received to enable a device which is already enabled, in step 635 an entry is made in an error log in the license server 54 (FIG. 1). One skilled in the art understands that data representing any aspect of any transaction between entity locations 70, 78, 79 and the vendor location 72 may be logged. In either event, in step 640, this usage key is retrieved from the license key storage device 56 and sent to the system controller 86 at the entity location 70 via the WAN 53, gateway 52 and LAN 50.

In step 642, the system controller 86 stores the received usage key for the desired device in the persistent key storage device 82. More specifically, in the illustrated embodiment the usage key is stored in the KEY column of the record in the table 300 (FIG. 3) associated with the desired device 21, 22, 2N. In step 645, the desired device is enabled by sending the newly received usage key to the hardware controller 41, 42, 4N associated with the desired device as described above. This device is now ready to be used by the user. In the manner described above the license server 54 operates as an activation processor, deriving an enabling message based on the usage key retrieved from the license key storage device 56 and communicating that enabling message to the selected individual device 21, 22, 2N to activate that device.

The license server 54 (FIG. 1) may be implemented as a user interface generator, which is capable of initiating generation of a signal representing a display image incorporating the device information stored in the license key storage device. More specifically, in the illustrated embodiment the user interface generator may be implemented as a web server. In this embodiment, requests may be received from the WAN 53 in the form of a message including a request to return a signal representing the image of a web page. In response, the user interface generator in the license server 54 generates a message including the display image representative signal. This message contains data describing a web page. The communications processor in the license server 54 returns the web page description data to the requester through the WAN 53. The system controller 86 operates as a web page browser interacting with a user at the client management console 90.

FIG. 6 is a more detailed block diagram of the license server 54 illustrated in FIG. 1. In FIG. 6, the license server 54 is implemented as a web page server including an executable application which generates data representing web pages programmatically. More specifically, in the illustrated embodiment a Java platform provides the necessary support to provide the functions described above. In particular, Java server pages are used to provide the functionality. The Java server page platform provides respective Java Bean executable procedures, termed servlets, to provide respective functions. The particular servlet executed is controlled by data in the received request message.

In FIG. 6, usage request messages are received from the WAN 53 (FIG. 1) and supplied to an input terminal of a servlet controller 542. An output terminal of the servlet controller 542 is coupled to an input terminal of a Java server page (JSP) generator 544. An output terminal of the JSP generator 544 provides data representing a web page image generated as a response to the request from the WAN 53. A Java Bean processor 546 is bidirectionally coupled to the JSP generator 544. The Java Bean processor 546 is also bidirectionally coupled to a license key storage database 56. In FIG. 6, the license key storage database is distributed among a plurality of database storage devices, 562, 564, 56N.

The operation of the license server 54 illustrated in FIG. 6 may be better understood by reference to FIG. 5. The system controller 86 (FIG. 1) at the entity location 70 sends a request to the license server 54 at the vendor location 72 to enable a device in step 620. This request is in the form of one or more messages containing respective request uniform resource locators (URLs) which include data representing at least the identity of a desired hardware device 21, 22, 2N, and the entity ID. The request URL messages are received by the servlet controller 542. The servlet controller 542 recognizes the respective URLs as a request for a JSP page and forwards the request to the JSP generator 544. The JSP generator 544 conditions the Java Bean processor 546 to select and execute at least one appropriate executable procedure as specified in the request URLs. For example, in response to a request to enable a device, the Java Bean processor 546 is conditioned to execute one or more executable procedures which perform the actions illustrated in the dashed box of FIG. 5.

One skilled in the art understands that use of the Java platform extends server functionality by providing executable procedures, termed Java Bean servlets, to perform specific services within the Java code framework. The platform also allows for additional servlets to be added as necessary. One servlet or set of servlets provides the capability to enable a hardware device at an entity location, as described in this application; another servlet or set of servlets may provide login and logout capability for users; another servlet or set of servlets may provide the ability to add users and/or modify account information related to a user; and so forth. The Java code framework also provides the capability to access other resources on the server processor system. For example, Java database connectivity (JDBC) enables Java Bean servlets to interact with databases; and the Java connector application program interface (API) enables Java Bean servlets to access enterprise information sources. In the illustrated embodiment, the servlets which enable a hardware device at an entity location may access the license key storage database 56 (FIG. 1) via JDBC; the login/logout and user registration servlets may access a user information database; other servlets may access other databases and server capabilities, to provide the respective services.

Execution of the appropriate servlet by the Java Bean processor 546 results in acquiring from the user, and/or providing to the JSP generator 544, the data necessary to respond to the request. For example, in order to enable a hardware device 21, 22, 2N (FIG. 1) the user is provided with an inventory of devices used by the entity. The user selects a desired hardware device and selects a term desired (i.e. purchase, rental, or lease). The Java Bean processor 546 conditions the JSP generator to enable the desired device for the selected term.

More specifically, in the illustrated embodiment the system controller 86 (FIG. 1) sends a message, including the entity ID, to the license server 54 requesting a list of available hardware devices 21, 22, 2N. The servlet controller 542 receives that request and forwards it to the Java Bean processor 546. The Java Bean processor 546 executes a servlet which accesses the distributed license key storage database 56 via JDBC to retrieve the records from the table 200 (FIG. 2) representing hardware devices at the entity location 70, 78, 79 specified in the request URL. As described above, information related to more than one entity 70, 78, 79 may be stored in the table 200 in the license key storage database 56. The servlet retrieves information related to hardware devices 21, 22, 2N at the entity location making the request, as requested by the user.

In the illustrated embodiment, this entity is “Bed Cnty” The information related to the hardware devices 21, 22, 2N at this entity location are retrieved and supplied to the JSP generator 544. The JSP generator 544 generates data representing a display image incorporating this device information. In the illustrated embodiment, the display image representative data is in the form of hypertext markup language (HTML) code.

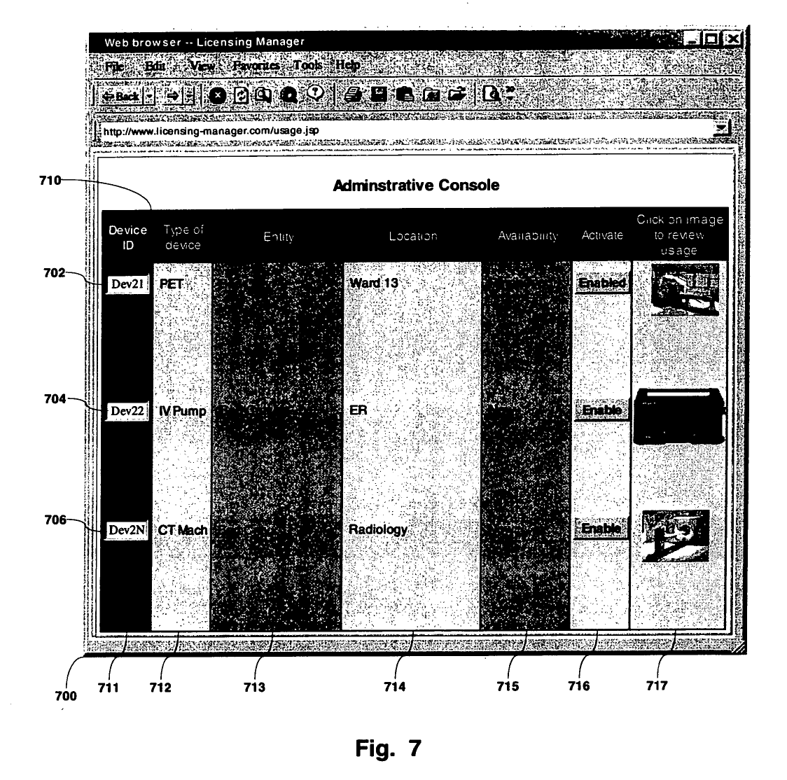

FIG. 7 is an illustration of an exemplary display image 700 showing the available devices, the current terms governing their usage and other information related to the devices 21, 22, 2N (FIG. 1) at the entity location 70. The display image 700 illustrates the device information in table form 710. The table 710 contains rows, representing respective hardware devices 21, 22, 2N at the entity location 70. The top row 702 displays data relating to device 21, the second row 704 displays data related to device 22 and the third row 706 displays data related to device 2N. One skilled in the art understands that more than three rows may be displayed, and may be accessed in a known manner by using scroll bars and/or by using respective screens accessed, e.g. by “previous” and “next” buttons. One skilled in the art also understands that the user may request that subsets of the devices 21, 22, 2N be displayed. For example, only devices of a selected type (e.g. IV pumps) be displayed.

The table 700 also includes columns displaying respective data related to the associated device 21, 22, 2N (FIG. 1). The first column 711 displays the device ID, the second column 712 displays the type of device, the third column 713 the entity ID, the fourth column 714 the location within the entity, the fifth column 715 the availability for purchase, rent or lease, and the seventh column 717 a picture of the device. This information is stored in respective columns in the table 200 (FIG. 2) stored in the license key storage device 56. The sixth column includes a button which may be used to enable a previously disabled device. As described above, device 21 is purchased and enabled. Thus, the button for device 21 is disabled, indicated by the label being grayed out. Devices 22 and 2N are available for purchase, rental or lease. Thus, the buttons for devices 22 and 2N are enabled, indicated by the label being dark. If a device is rented or leased (not shown), then the button is disabled, as in row 702, and the end of the term, is displayed in the fifth column 715.

The JSP generator 544 (FIG. 6) composes a message including data representing a signal carrying the display image of FIG. 7. In the illustrated embodiment, the message is in the form of one or more TCP/IP packets containing HTML coded data representing the display image. One skilled in the art will understand than any type of message capable of transmitting the display image signal from the license server 54 (FIG. 1) at the vendor location 72 to the system controller 86 at the entity location 70 may be used. This message is communicated to the system controller 86 at the entity location 70. The system controller 86 conditions the management console 90 to display the image represented by the signal carried in the received message.

The system controller 86 (FIG. 1) conditions the management console 90 to display the display image 700 (FIG. 7) and to receive user input from the user. The user at the management console 90 may activate the “Enable” button in the row corresponding to a desired hardware device, e.g. in row 704 corresponding to device 22. In response the system controller 86 sends a message, including the entity ID and data identifying the desired device (22), to the license server 54 requesting a return message updating the terms governing usage of the device.

The servlet controller 542 (FIG. 6) in the license server 54 receives this request, and recognizes that it is requesting the activation of a desired device. The servlet controller 542 sends the request to the JSP generator 544, which conditions the Java Bean processor 546 to execute the executable procedure (servlet) which activates devices. Before the device may be activated, the desired term of activation is necessary. The Java Bean processor 546 conditions the JSP generator 544 to generate data representing a display image soliciting this information. The JSP generator 544 generates a message carrying a signal representing the display image soliciting the information.

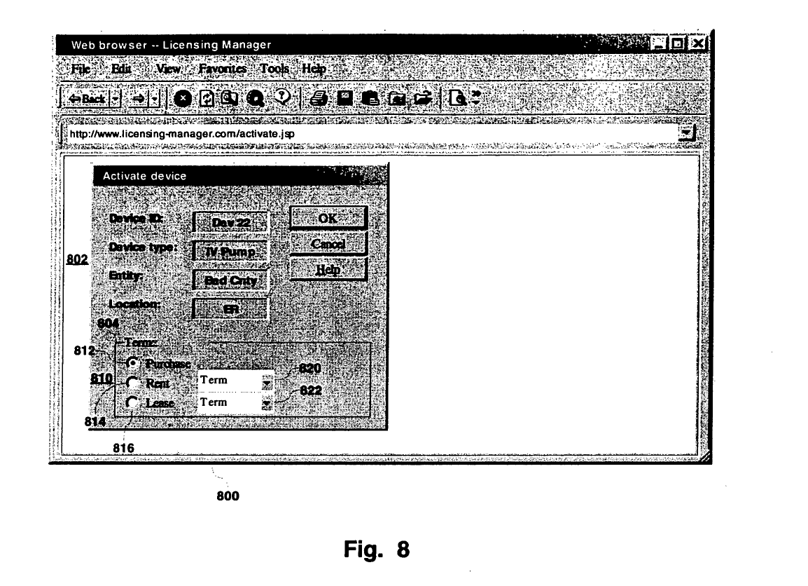

FIG. 8 is an illustration of a display image 800 for soliciting further information necessary for changing the usage status of a device 21, 22, 2N (FIG. 1). The top portion 802 of the display image 800 displays a copy of the information in the row of the table 700 (FIG. 7) corresponding to the button which was activated. The user may verify that the correct button was pressed by reviewing this information. The bottom portion 804 of the display image 800 solicits the desired type of activation. Three radio buttons 810 (meaning only one may be activated at a time) are provided. A top radio button 812 represents a desire to purchase the desired device, the middle radio button 814 represents a desire to rent the desired device and the bottom radio button 816 represents a desire to lease the desired device.

In the illustrated embodiment, the JSP page generated by the JSP generator 544 (FIG. 6) includes a Javascript executable procedure which will operate when the user selects one of the radio buttons 810. If the selected radio button is the rent button 814 then the Javascript executable procedure enables the term text box 820 to enable the user to select a rental term. The down arrow at the right side of the text box 820 allows a user to select one of a plurality of prespecified terms, for example, one month, three months, six months, etc. In a similar manner, if the selected radio button is the lease button 816, then the Javascript executable procedure enables the term text box 822 to enable the user to select a lease term. The down arrow at the right of the text box 822 allows a user to select one of a plurality of prespecified terms, for example, six months automatic renewable, one year automatic renewable, one year manual renewable, and so forth. One skilled in the art understands that the down arrows on text boxes 820 and 822 are optional, and that the terms given above are only examples. When the selections are complete, the user may activate the “OK” button to condition the system controller 86 (FIG. 1) to send a message to the license server 54 to return this information.

The servlet controller 542 (FIG. 6) receives the message containing this information and sends it to the JSP generator 544 which, in turn, forwards it to the Java Bean processor 546. The Java Bean processor 546 now has the entity ID, the desired hardware device and the desired type and term of activation. Referring again to FIG. 5, the Java Bean processor 546 executes a servlet which performs the steps 630, 635, 637, and 639 illustrated within the dashed box. In this manner, a usage key is created and stored via JDBC in the license key storage device 56 and a bill sent to the entity if this device is newly activated. In step 640, the Java Bean processor 546 retrieves the usage key from the license key storage device 56 and sends data representing the entity ID, the desired device 21, 22, 2N (FIG. 1) and the usage key identifying the terms governing use of the device to the JSP generator 544. The JSP generator produces a message identifying the device 21, 22, 2N and the terms governing use of the device. The JSP generator 544 communicates this message to the entity location 70.

In step 642 (FIG. 5), the system controller 86 (FIG. 1) receives this message and stores the usage key in the KEY column of the appropriate row of the table 300 (FIG. 3) in the persistent key storage device 82. In step 645, the system controller activates the device in the manner described above.

The system described above and illustrated in the Figure allows hardware devices initially integrated in the computer system to be enabled and disabled on an a-needed basis. For example, should a server computer require more processing power to handle a period of peak load, a user may use the management console to automatically enable additional processors or memory modules on a temporary basis by renting or leasing them. Similarly, should a user, e.g. a doctor, nurse, therapist, etc., require a particular patient monitoring or treatment device, either permanently or on a temporary basis, that user may automatically enable that device using the management console by purchasing, renting or leasing it. The time and effort required for a user to contact the vendor by phone or mail, and the time and effort required for an IT person to activate a device is minimized or eliminated.

1. A system for managing a device at a location of an associated entity, comprising:
a repository of device information identifying:
the entity associated with said device,
the device, and
a characteristic indicating terms governing usage of said device by said entity; and
a communication processor for communicating a message to the entity location for identifying said device and for updating said terms governing usage of said device.

2. The system of claim 1 further comprising a user interface generator for initiating generation of a signal representing a display image incorporating said device information wherein the communications processor communicates a message including the display image representative signal.

3. A system for managing a device, comprising:
a device at a location of an associated entity;
means for controlling the usage of the device;
a repository of device information identifying:
the device,
an entity associated with said device, and
a characteristic indicating terms governing usage of said device by said entity;
a user interface generator for initiating generation of a display image incorporating said device information; and
a communication processor for communicating a message to the device controlling means for identifying said device and for updating said terms governing usage of said device.

4. The system of claim 3 wherein the device controlling means comprises a system controller for communicating a message to the communications processor requesting a message updating said terms governing usage of said device.

5. A system for use in managing a plurality of different types of devices, comprising:
a repository of device information identifying:
a plurality of different types of devices,
an entity associated with at least one of the plurality of devices, and
a characteristic indicating terms governing usage of said at least one device by said entity;
a user interface generator for initiating generation of a display image incorporating said device information; and
a communication processor for communicating a message to the entity for identifying an individual device and for updating said terms governing usage of said individual device.

6. The system according to claim 5, wherein said plurality of different types of devices comprise different devices used in delivering healthcare to a patient.

7. The system according to claim 5, wherein:
said characteristic indicating terms governing usage of said at least one device by said entity indicates an individual device is at least one of, (a) owned, (b) rented, (c) leased, and (d) available for purchase, rent or lease; and
said message to said entity changes said terms.

8. The system according to claim 5, wherein said repository of device information identifies at least one of, (a) operational status of an individual device, (b) availability of an individual device for usage by said entity and (c) status of a request to renew said terms governing usage of an individual device.

9. The system according to claim 5, wherein said repository of device information identifies an inventory of devices used by said entity.

10. The system according to claim 5, wherein said repository of device information comprises a plurality of distributed databases.

11. The system according to claim 5, wherein said entity is at least one of, (a) an organization, (b) a subunit within an organization and (c) an organization subunit associated with a particular location.

12. The system according to claim 5, wherein:
said repository includes said device information for a plurality of different entities; and
said user interface generator initiates generation of a display image incorporating device information of a selected entity in response to user command.

13. The system according to claim 5, wherein said user interface generator initiates generation of a display image incorporating device information for a selected type of device in response to user command.

14. The system according to claim 5, wherein:
said repository includes a usage key for use in enabling a selected individual device; and said system further comprises; and
an activation processor for deriving an enabling message based on an usage key retrieved from said repository and communicating said enabling message to said selected individual device to activate said selected individual device.

15. The system according to claim 14, wherein said communication processor communicates a message to a billing processor identifying said selected individual device is activated for initiating billing for use of said selected individual device.

16. The system according to claim 5, wherein:
said repository includes a usage key for use in enabling a particular function of a selected individual device; and said system further comprises; and
an activation processor for deriving an enabling message based on a usage key retrieved from said repository and communicating said enabling message to said selected individual device to enable said particular function.

17. The system according to claim 16, wherein said communication processor communicates a message to a billing processor identifying said particular function of said selected individual device is activated for initiating billing for use of said particular function.

18. The system according to claim 16, including:
an interface processor for receiving identification information of said user requesting activation of said particular function; and
said communication processor generates a message to include data identifying said particular function and user identification information to enable billing said identified user for activating said particular function.

19. The system according to claim 18, wherein said data identifying said particular function comprises a code uniquely identifying said particular function.

20. The system according to claim 16, wherein said communication processor establishes communication with an entity and acquires said usage key from said entity for storage in said repository in response to a user request to activate said particular function.

21. The system according to claim 20, wherein said user request to activate said particular function is derived in response to at least one of, (a) power-on of said particular function and (b) a user selection command entered via a displayed user interface image.

22. A system for use in managing usage of a plurality of different types of devices, comprising:
at least one repository of device information identifying:
a plurality of different types of devices,
an entity associated with an individual device,
a usage code for use in enabling an item comprising at least one of, (a) an individual device selected from said plurality of different types of devices and (b) a particular function of a selected individual device, and
a characteristic indicating terms governing usage of an item by said entity;
a user interface generator for initiating generation of a display image identifying said plurality of different types of devices and said characteristic; and
an activation processor for deriving an enabling message based on a usage key retrieved from said repository and communicating said enabling message to said selected individual device to enable said particular item.

23. The system according to claim 22, including a communication processor for communicating a message to the entity for enabling said item and for updating said terms governing usage of said individual device.

24. A method for use in managing a plurality of different types of device, comprising the activities of:
acquiring device information identifying:
a plurality of different types of devices,
an entity associated with an individual device, and
a characteristic indicating terms governing usage of an individual device by said entity;
initiating generation of a display image incorporating said device information; and
communicating a message to the entity for identifying an individual device and for updating said terms governing usage of said individual device.

25. A method for use in managing activation of a plurality of different types of device, comprising the activities of:
acquiring device information identifying:
a plurality of different types of devices,
an entity associated with an individual device,
a usage key for use in activating an item comprising at least one of,
(a) an individual device selected from said plurality of different types of devices and (b) a particular function of a selected individual device, and
a characteristic indicating terms governing usage of an item by said entity;
initiating generation of a display image identifying said plurality of different types of devices and said characteristic; and
deriving an enabling message based on a usage key retrieved from said repository and communicating said enabling message to said selected individual device to activate said particular item.
